(19) United States
(12) Patent Application Publication
(10) Pub. No.: US 2012/0042261 A1
(43) Pub. Date: Feb. 16, 2012

(54) SUB-COMPONENT INSTANTIATION AND SYNCHRONIZATION USING A SHARED WORKER

(75) Inventors: Derek Phillips, Waterloo (CA); Andrew Grieve, Waterloo (CA); Matthew Bolohan, Kitchener (CA); Robert Kroeger, Waterloo (CA)

(73) Assignee: GOOGLE INC., Mountain View, CA (US)

(21) Appl. No.: 12/855,561

(22) Filed: Aug. 12, 2010

(51) Int. Cl. G06F 3/01; G06F 15/16

(52) U.S. Cl. 715/744

(57) ABSTRACT

The techniques of this disclosure are directed to a shared worker application configured to create one or more instantiations and/or to locally synchronize status of one or more sub-component instantiations for one or more web applications. In one example, a shared worker of a browser facilitates creation of sub-component instantiations, by acquiring software defining the sub-component from a memory of a computing device on which the browser is operating, or via a network, and providing the software local to the computing device for execution to create the instantiation of the sub-component. In another example, a shared worker of a browser as described herein facilitates status updates for multiple sub-component instantiations local to a computing device upon which a browser is operating.

### TECHNICAL FIELD

This disclosure relates to network communications. More specifically, this disclosure relates to web applications configured to operate in a web browser on a communications device coupled to a network.

### BACKGROUND

A web browser is generally an application (e.g., computer program) that operates on a computing device (e.g., a personal computer, laptop, personal digital assistant (PDA), cellphone, smartphone, or the like) to enable information available over a network (e.g., the Internet) to be accessed. A web browser may be configured to access information available over a network by utilizing uniform resource identifiers (URIs), which indicate a location by which information may be accessed. A typical web browser may be configured to present network-accessible and/or other information to a user in one or more browser windows, or browser tabs within the browser. A web browser may enable a user to open a plurality of web-browser windows, or tabs within a web browser window, simultaneously.

A web application is generally a software application that is accessible via a web browser as discussed above. For example, a web application may be a document, such as a hyper text markup language (HTML) document. A document web application may be configured to present information available over a network visually to a user. A document web application may present to a user one or more links (e.g., to a URI) to available information. A user may be provided an ability to select one or more links, which may result in presentation of a new web document, including information accessible via a URI associated with the link. User selection of one or more links of a web document may instead, or in addition, execute one or more non-document web applications to perform a desired function within a browser.

Some web applications may be configured to operate one or more sub-components. A sub-component operated by a web application may perform a desired task for the web application. Sub-components may present some form of visual depiction to a user, for example, an instant messaging (e.g., chat) window, a contact picker, a calendar event entry/update window, a photo upload and/or presentation sub-window, an audio/video presentation/player window, or any other form of pop-out or embedded sub-window of a primary, or host, web application. In other examples, a primary or host web application may operate one or more sub-components configured to perform non-visual functions for the web application.

### SUMMARY

This disclosure is directed to techniques for using a shared worker application to create one or more sub-component instantiations, or visual user interface (UI) elements, for at least one host web application. This disclosure is further directed to techniques for using a shared worker application to enable the updating a status of one or more sub-component instantiations (UI elements) local to a computer device upon which the shared worker and the sub-component instantiations are operating (e.g., without accessing a network).

The techniques of this disclosure may provide for improvements in creating sub-component instantiations and or updating sub-component instantiation status, because by using a shared worker, a need to access a network to acquire software defining a sub-component (UI element) and/or to communicate sub-component instantiation status updates, may be minimized. Further, software defining a sub-component (UI element) may not rely on software defining a host web application, which may provide for improvements in management of a software release cycle for one or more of a host web application and a sub-component.

In one example, a method for providing updates to visual user interface elements is described herein. The method includes executing, by a browser executing on a computing device, a shared worker application configured to provide updates to user interface (UI) elements rendered by the computing device. The method further includes executing, by the browser, a first web application configured to present a visual rendering of a first UI element. The method further includes executing, by the browser, a second web application configured to present a visual rendering of a second UI element, wherein the second UI element is substantially similar to the first UI element. The method further includes receiving, by the shared worker application and from the first UI element, a status update for the first UI element, wherein the status update comprises an update to visual content to be provided by the first UI element. The method further includes updating, by the shared worker application, the visual rendering of the first UI element and the second UI element to reflect the received status update.

An article of manufacture comprising a computer-readable storage medium storing instructions is also described herein. The instructions cause a computing device to execute, by a browser executing on a computing device, a shared worker application configured to provide updates to user interface (UI) elements rendered by the computing device. The instructions further cause the computing device to execute, by the browser, a first web application configured to present a visual rendering of a first UI element. The instructions further cause the computing device to execute, by the browser, a second web application configured to present a visual rendering of a second UI element, wherein the second UI element is substantially similar to the first UI element. Receive, by the shared worker application and from the first UI element, a status update for the first UI element, wherein the status update comprises an update to visual content to be provided by the first UI element. The instructions further cause the computing device to update, by the shared worker application, the visual rendering of the first UI element and the second UI element to reflect the received status update.

A device is also described herein. The device includes a browser configured to execute a shared worker application configured to provide updates to user interface (UI) elements rendered by the computing device, and wherein the browser is further configured to execute a first web application configured to present a visual rendering of a first UI element and a second web application configured to present a visual rendering of a second UI element. The device further includes means for receiving, from the first UI element and by the shared worker application, a status update for the first UI element, wherein the status update comprises an update to visual content to be provided by the first UI element. The device further includes means for updating, by the shared worker application, the visual rendering of the first UI element and the second UI element to reflect the received status update.

A method for presenting a visual user interface element via a web application is further described herein. The method includes executing, by a browser executing on a computing device, a host web application. The method further includes executing, by the browser, a shared worker configured to provide at least one user interface (UI) element to at least one host web application executing on the computing device. The method further includes receiving, from the host web application and by the shared worker, a request to create a visual rendering of a user interface (UI) element that presents a visual depiction of functionality of the UI element associated with the host web application. The method further includes acquiring, by the shared worker, software executable to present the visual rendering of the UI element. The method further includes storing, by the shared worker, the acquired software in a memory of the computing device. The method further includes executing the acquired software to create the visual rendering of the UI element presented in conjunction with the host web application in response to the request.

An article of manufacture comprising a computer-readable storage medium that stores instructions is also described herein. The instructions cause a computing device to execute, by browser executing on a computing device, a host web application. The instructions further cause the computing device to execute, by the browser, a shared worker configured to provide at least one user interface (UI) element to at least one host web application executing on the computing device. The instructions further cause the computing device to receive, from the host web application and by the shared worker, a request to create a visual rendering of a user interface (UI) element that presents a visual depiction of functionality of the UI element associated with the host web application. The instructions further cause the computing device to acquire, by the shared worker, software executable to present the visual rendering of the UI element. The instructions further cause the computing device to store, by the shared worker, the acquired software in a memory of the computing device. The instructions further cause the computing device to execute the acquired software to create the visual rendering of the UI element presented in conjunction with the host web application in response to the request.

The details of one or more embodiments of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1A is a conceptual diagram illustrating one example of a computing device and a browser executing on the computing device that includes a shared worker application consistent with the techniques of this disclosure.

FIG. 1B is a conceptual diagram illustrating one example of a host web application and sub-components instantiations of the host web application consistent with the techniques of this disclosure.

FIG. 2 is a conceptual diagram illustrating one example of a computing device and a browser executing on the computing device that includes a shared worker application and first and second user interface elements (UI) consistent with the techniques of this disclosure.

FIG. 3 is a conceptual diagram illustrating various examples of computing hardware configured to operate a web browser that incorporates a shared worker application consistent with the techniques of this disclosure.

FIG. 4 is a block diagram illustrating one example of a browser that operates a shared worker application that enables instantiation and/or synchronization of sub-component status consistent with the techniques of this disclosure.

FIG. 5 is a conceptual diagram illustrating one example a shared worker application operable to synchronize status of sub-component instantiations consistent with the techniques of this disclosure.

FIG. 6 is a block diagram illustrating one example of components of a shared worker application operable to enable synchronization and/or instantiation of sub-components consistent with the techniques of this disclosure.

FIG. 7 is a flow chart diagram illustrating one example of a method of creating a sub-component instantiation by a shared worker application consistent with the techniques of this disclosure.

FIG. 8 is a flow chart diagram illustrating one example of a method of updating sub-component status consistent with the techniques of this disclosure.

FIG. 9 is a block diagram illustrating one example of a shared worker operable to instantiate and/or to update status of one or more sub-component instantiations across domains consistent with the techniques of this disclosure.

FIG. 10 is a flow chart diagram illustrating one example of a method of updating user interface (UI) element status consistent with the techniques of this disclosure.

FIG. 11 is a flow chart diagram illustrating one example of a method of providing a interface (UI) element to a host web application consistent with the techniques of this disclosure.

### DETAILED DESCRIPTION

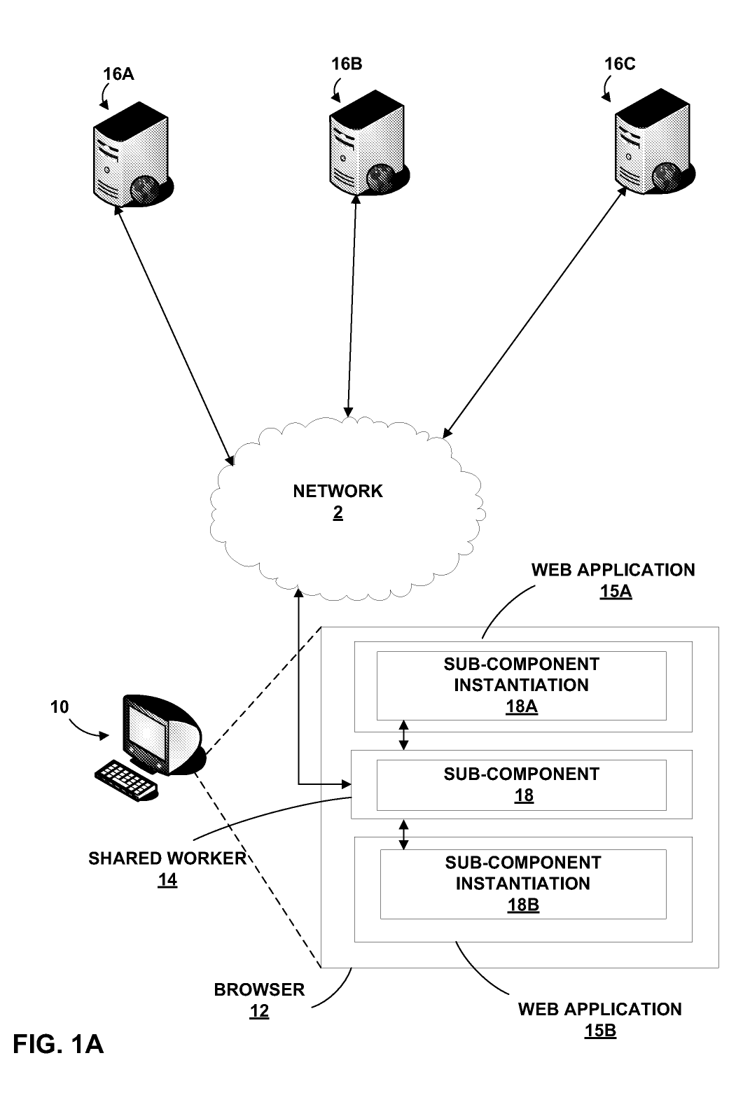

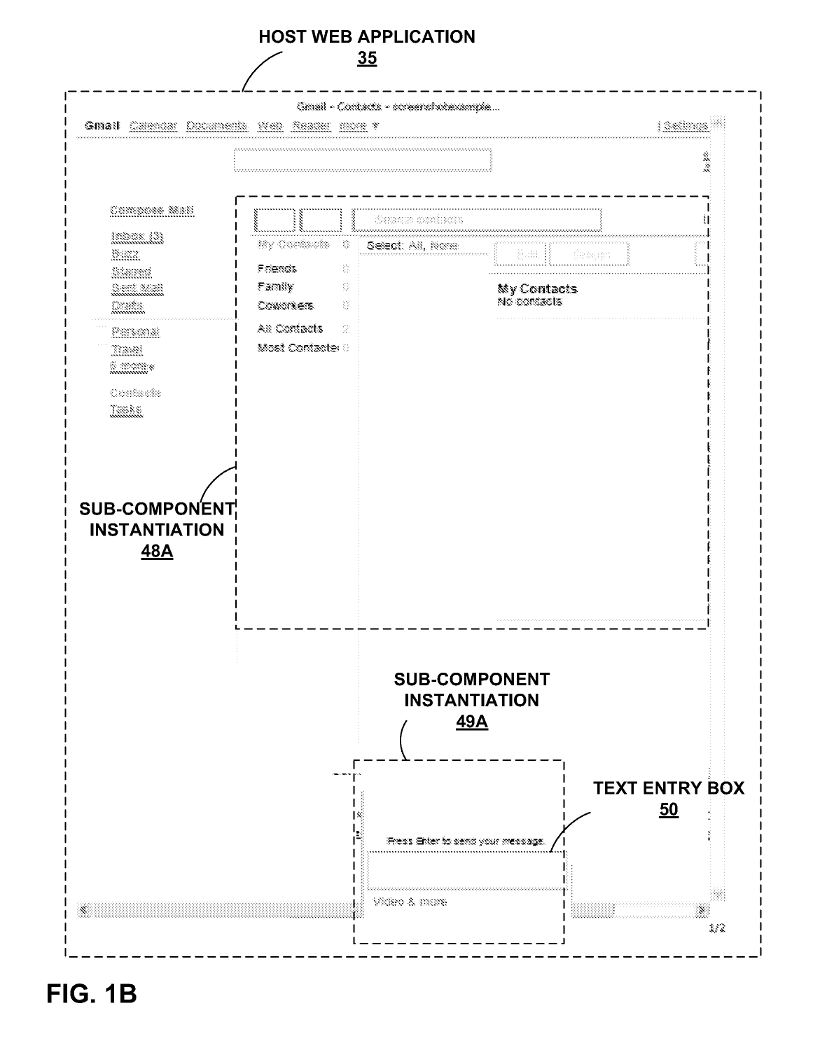

FIG. 1A is a conceptual diagram illustrating one example of a computing system including a browser 12 that incorporates a shared worker application 14 consistent with this disclosure. FIG. 1A depicts a local computing device 10. Local computing device 10 may be coupled to one or more other computing devices via a network 2. Network 2 may be the Internet. Network 2 may instead be any other network, e.g., a public/private network or a wireless network. Computing device 10 depicted in FIG. 1 is a personal desktop computer. Although not shown in FIG. 1A, computing device 10 may be any computing device configured to communicate over a network, for example a laptop computer, a cellular phone, tablet computer, or any other device configured to communicate information via network 2, whether the device's primary purpose is network-based communication or not. Another example of a computing device is a television configured to communicate over a network 2. Further, computing device 10 may be coupled to network 2 by any number of known mechanisms for network communications, for example wired connections (e.g., Ethernet) or wireless connections (e.g., Wi-Fi, cellular) to network 2.

As depicted in FIG. 1A, computing device 10 is coupled to a plurality of network server computing devices 16A-16E via network 2. In order to access information accessible from network servers 16A-16E, a browser application 12 may run on local computing device 10. Browser 12 may be configured to run within a local operating system of computing device 10. Non-limiting examples of known browser applications include Microsoft Explorer™, Apple Safari™, Mozilla Firefox™ and Google Chrome™ browser. Non-limiting examples of known operating systems for desktop and/or laptop computers may include Microsoft Vista™, Apple Snow Leopard™, or Linux. Examples of known operating systems for mobile devices (e.g., smartphones, netbooks, etc.) include Microsoft Windows Mobile®, Apple Iphone OS®, and Google Android™ mobile technology platform.

Browser 12 may enable a user to manipulate access to information accessible via network 2. For example, browser 12 may provide a user with an ability to enter one or more uniform resource indicators (URIs, e.g., www.google.com) in order to access a web application, such as, for example, a hypertext markup language (HTML) document. A web application, and/or information used by a web application, may be stored on one or more network servers 16A-16E. Browser 12 may be configured to access web applications and/or other information stored on network servers 16A-16E for presentation of visual information to a user of computing device 10, among other uses.

As shown in FIG. 1A, browser 12 may present, via a window or tab of browser 12, one or more web applications 15A-15B to a user. Only two web applications 15A-15B are shown in the example of FIG. 1A, however, a single web application, or more than two web applications may be presented to a user simultaneously via browser 12. In one example, one or more of web applications 15A-15B are web application configured to present a visual depiction to a user (e.g., an HTML document). One or more of web applications 15A-15B may further present functionality to a user, for example enable the user to communicate, navigate to other web applications, view a map, view a calendar, play a game, listen to music, watch a video, access (e.g., upload) information local to a user's computing device), or any other form of functionality.

As also shown in FIG. 1A, browser 12 includes shared worker 14. In various examples, shared worker 14 is configured to acquire network accessible information, for example information stored on one or more network servers 16A-16C in the example of FIG. 1, and provide acquired information to one or more web applications 15A-15B. Shared worker application 14 may further be configured to store acquired information in a local memory of a computing device 10, so that shared worker 14 may use the information to satisfy one or more requests for the same or similar information from the one or more web applications 15A-15B. For example, if web application 15A has requested certain network accessible information that shared worker 14 acquired in response to the request and stored in local memory, if web application 15B communicates a request for similar information, shared worker may access information stored in local memory to satisfy the request from web application 15B.

Shared worker 14 may further create instantiations of and/or enable communication with/between instantiations of one or more sub-components 18 according to the techniques of this disclosure. A sub-component 18 as discussed herein is a predefined implementation of web application functionality configured to be used by more than one web application. A sub-component instantiation 18A, 18B as described herein refers to the implementation of sub-component functionality for a particular web application 15A, 15B. In some examples, a sub-component instantiation 18A, 18B includes a visual rendering of web application functionality. For example, a web application 15A, 15B may employ one or more instantiations 18A, 18B of a sub-component 18 such as an instant messaging (chat) window, a contact picker, a calendar event entry/update window, a photo upload and/or presentation sub-window, or an audio/video presentation/player window, or any other functionality that may be used by more than one web application.

A shared worker 14 as described herein may be software executable by a computing device to acquire network accessible information and/or to update sub-component instantiations (e.g., 18A, 18B)/visual user interfaces of web applications executed in a browser 12. In one specific example, shared worker 14 may be one or more independent threads of software (program instructions) written in the JavaScript language. In other examples, shared worker 14 may include software written in any other language.

FIG. 1B illustrates one non-limiting example of a host (primary) web application 45 (HTML document associated with the URL www.mail.google.com) that presents two examples of instantiations 48A and 49A of different sub-components. As described herein, a sub-component is software that defines functionality configured to be used by more than one web application. An instantiation of a sub-component as described herein is the implementation of a sub-component with a web application.

A first sub-component instantiation 48A as shown in FIG. 1B is an instantiation of a contacts picker sub-component. As shown, sub-component instantiation 48A presents, on a portion of a visual depiction of host web application 35, a visual depiction of sub-component functionality. For example, sub-component instantiation 48A provides a user with visual controls to search contacts, select contacts, add contacts, view suggested contacts, and/or find duplicate contacts within a user's already defined contacts.

A second sub-component instantiation 49A is also shown in FIG. 1B. The second sub-component instantiation 49A is an instantiation of a chat window sub-component. The chat window presents to a user content of a chat, presumably with another user. Although not shown in FIG. 1B, the chat window may show messages sent or received by the user. As shown in FIG. 1B, the chat window also presents a text entry box 50 for a user to enter messages. The examples of FIG. 1B are provided merely for explanatory purposes, and are intended to be non-limiting. A sub-component as described herein is any uniform functionality that may be utilized by more than one web application, or more than one instantiation of a single web application.

Using sub-components by web applications may be advantageous, because each web application using a particular sub-component need not independently define that sub-component. As such, code (e.g., Java script) defining a sub-component may be re-used instead of re-written for each web application where functionality of a sub-component is desired. Further, using pre-defined sub-components may make functionality integration less complex. In addition, common sub-components may improve a user experience by providing uniformity across a number of different web applications, e.g., a user need not learn how to operate particular functionality anew each time the user uses similar functionality for a different web application. For example, a user may be presented an identical contacts picker sub-component via both an email web application (e.g., gmail: www.gmail.com) and a contacts web application (e.g., www.google.com/contacts).

However, known browser implementations 12 may provide sub-component functionality in a relatively inefficient way. For example, according to known browser implementations, code defining sub-component functionality may be embedded in code defining a web application itself. Embedded sub-component code may be undesirable, because it may be difficult to update code defining the sub-component independent of a release cycle of a host web application that uses the sub-component.

Also, such code defining a web application (and associated sub-component code) is typically accessed from one or more network servers (e.g., servers 16A-16C in the example of FIG. 1A). As such, in order for two web applications 15A, 15B operating in a browser 12 to use the same sub-component 18, code defining instantiation of the sub-component 18 is accessed from the one or more network servers twice. Accessing information over a network 2 unnecessarily may be undesirable, especially where computing device 10 is coupled to one or more network servers 16A-16C via a slow and/or intermittent network 2 connection (e.g., a mobile network such as a cellular network).

The instantiation of sub-components 18 via a network per web application may also be undesirable for other reasons. For example, for some sub-components (e.g., a chat window, contacts picker), it may be desirable to synchronize status between two or more sub-component 18 instantiations. For example, where a user has two browser windows or tabs open to display two (same or different) web applications that employ chat window sub-components 18A-18B, it may be desirable to update the second chat window when a message is typed into the first chat window.

According to known browser implementations, in order to perform such an update, a first sub-component instantiation 18A may communicate a change in status (e.g., the new message) to one or more network servers 16A-16C. The one or more network servers 16A-16C may then communicate the status update to a web application hosting the second sub-component instantiation 18B. The hosting web application may then accordingly update the second sub-component instantiation 18B. This implementation may be undesirable, because the synchronization status requires communication over network 2 to synchronize status between the first and second sub-component instantiations 18A, 18B. This may be specifically undesirable where computing device 10 is coupled to network servers 16A-16C via a slow and/or intermittent network 2 connection (e.g., a mobile network such as a cellular network). In another example, known browser implementations may require that information associated with each sub-component instantiation 18A, 18B is independently stored in a local memory of a computing device. This may also be undesirable, because the need to access memory is increased, and information may be unnecessarily duplicated in memory.

The techniques of this disclosure address the above-described deficiencies with known web browser implementations to create instantiations of sub-components for web applications and to share status updates between instantiations of sub-components. As such, as shown in FIG. 1A, browser 12 incorporates a shared worker application 14. In one example, the shared worker 14 may create an instantiation of one or more sub-components 18 (sub-component instantiations 18A, 18B represent instantiations of a single sub-component 18) for one or more web applications 15A, 15B. For example, upon a request from a web application 15A, shared worker 14 may acquire software code defining a sub-component 18 from one or more network servers 16A-16C over a network 2. The shared worker 14 may communicate the software code defining the sub-component 18 to web application 15A to create an instantiation 18A of the sub-component 18 for web applications 15A. In one example, shared worker 14 may analyze web application 15A to determine a suitable location for sub-component instantiation 18A. Shared worker 14 may further determine a shape of sub-component instantiation 18A. Shared worker 14 may, in one example, modify software code defining sub-component 18 to cater the software code to define the sub-component instantiation 18A to conform to a suitable location and/or size/shape for sub-component instantiation 18A relative to web application 15A.

Shared worker 14 may further store the software code defining the sub-component 18 in a local memory of computing device 10 upon which browser 12 is operating. As such, shared worker 14 may, upon a second request from a second web application 15B to create a second instantiation 18B of the same sub-component 18, create the second instantiation 18B of the sub-component 18 based on software code stored in local memory. Thus, according to the techniques of this disclosure, sharing of sub-components 18 via a shared worker 14 may reduce a need to access network 2 to acquire code to create an instantiation 18A, 18B of a sub-component 18.

In another example, the techniques of this disclosure provide for improved updating of one or more sub-component instantiations. For example, as shown in FIG. 1A, browser 12 is operable to present a first web application 15A to a user. The first web application 15A uses a first instantiation 18A of a sub-component 18. The first instantiations 18A of the sub-component 18 may have been created by shared worker 12 as described above. Sub-component instantiation 18A may receive an update. For example where the sub-component 18 is a chat window, sub-component instantiation 18A may receive a status update in the form of a chat message. According to known browser implementations, a web application using the sub-component instantiation 18A would itself, based on code of the web application, update the sub-component instantiation 18A (e.g., a visual rendering of sub-component functionality) to reflect the status update. According to techniques of this disclosure, instead of web application 15A itself updating a rendering of the sub-component instantiation 18A to reflect the status update, the status update may be sent to shared worker 14, and shared worker 14 may, in response, send software code that may be executed to render an updated version of the sub-component instantiation 18A.

In another example, the techniques of this disclosure provide for improved status synchronization for sub-component instantiations 18A, 18B of sub-component 18. For example, as shown in FIG. 1A, browser 12 is operated to present a first web application 15A and a second web application 15B to a user. The first and second web applications 15A, 15B may respectively present first and second instantiations 18A, 18B of sub-component 18. The first and second instantiations 18A-18B of sub-component 18 may have been instantiated by shared worker 12 as described above.

Shared worker 14 may enable communication of sub-component instantiation 18A, 18B status local to computing device 10. For example, first sub-component instantiation 18A may receive a status update (e.g., where sub-component 18A is an instant messaging window, sub-component 18A may receive a user message). Sub-component instantiation 18A (or host web application 15A) may communicate the status update to shared worker 14. Shared worker 14 may, upon receipt of the status update, communicate the status update to one or more of first sub-component instantiation 18A and second sub-component instantiation 18B. In some examples, communicating the status update to one or more of the first and second sub-component instantiations includes updating a visual depiction of the one or more sub-component instantiations.

In one example, communicating the status update to the one or more sub-component instantiations 18A, 18B may include communicating at least one software code portion updated to incorporate the received status update (from first sub-component instantiation 18A) to one or more of the host web applications 15A, 15B. Accordingly, sub-component instantiations 18A, 18B may be updated (e.g., by executing updated software code defining the sub-component) to reflect the status update of sub-component instantiation 18A (e.g., the user message may be displayed to the user via visual depictions of sub-component instantiations 18A, 18B). In some examples, shared worker 14 may further store a received status update (and/or software code updated to incorporate the status update) locally, for example in a temporary memory of computing device 10, such that the status update may be provided to another instantiation of sub-component 18 (not shown in FIG. 1). Thus, according to the techniques of this disclosure, sharing of sub-components instantiation 18A-18B status updates via a shared worker 14 may reduce a need to access network 2, because status updates are communicated local to a computing device 10 upon which browser 12 is operating. Also according to this example, because information associated with sub-component instantiations 18A, 18B may be stored in a single location by shared worker 14 and provided for sub-component instantiations 18A-18B as a need for the information arises, duplicative information stored in local memory may be minimized.

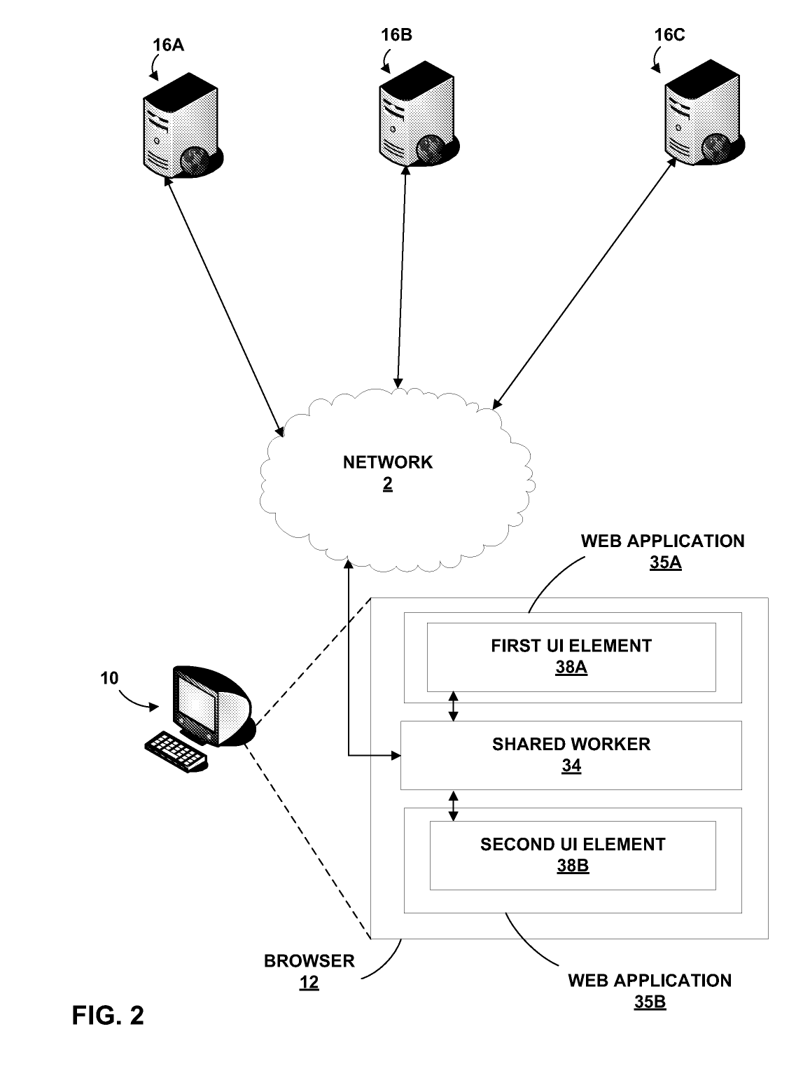

FIG. 2 is a conceptual diagram illustrating one example of a computing device and a browser 12 executing on the computing device that includes a shared worker application 34, and first 38A and second 38B user interface (UI) elements consistent with the techniques of this disclosure. As described above with respect to FIGS. 1A and 1B, a sub-component 18 may be described as a predefined implementation of web application functionality configured to be used by more than one web application.

A sub-component instantiation 18A, 18B may be described as the implementation of sub-component functionality for a particular web application 15A, 15B. For example, a sub-component instantiation 18A, 18B may be a visual rendering of sub-component 15 functionality for a particular web application. In this manner, as shown in FIG. 2, a sub-component instantiation 18A may be considered a first user interface (UI) element 38A. Similarly, a sub-component instantiation 18B may be considered a second UI element 38B. The first UI element 38A may be substantially similar to the second UI element 38B. For example, the first and second UI elements 38A and 38B may be configured as first and second instantiations of a particular sub-component, e.g., each of the first and second UI elements 38A and 38B visually represent the same or substantially similar functionality. In some examples, some functionality of UI element 38A may be shared with functionality represented by UI element 38B. In some examples, UI element 38A may represent additional functionality than UI element 38B, while still representing at least a portion of the functionality of UI element 38B (e.g., both UI element 38A and 38B may present to a user a chat window, contacts picker, or other functionality). As shown in FIG. 2, browser 12 may execute a shared worker application 34. Similar to the examples discussed above with respect to FIGS. 1A and 1B, shared worker application 34 may create UI elements 38A, 38B for one or more web applications (e.g., 35A, 35B in the example of FIG. 2). For example, upon a request from a web application 35A, shared worker 34 may acquire software code defining a first UI element 38A from one or more network servers 16A-16C over a network 2. In one example, shared worker 14 may analyze web application 35A to determine a suitable location for first UI element 38A. Shared worker 34 may further determine a shape of first UI element 38A. Shared worker 34 may, in one example, modify software code defining first UI element 38A (e.g., software code executable to render first UI element 38A via a display of computing device 10) to cater the software code to define the sub-component instantiation 38A to conform to a suitable location and/or size/shape for sub-component instantiation 38A relative to web application 35A.

Shared worker 34 may further store the software code defining the first UI element 38A in a local memory of computing device 10 upon which browser 12 is operating. As such, shared worker 34 may, upon a second request from a second web application 35B to create a second UI element 38B substantially similar to first UI element 38A, create the second UI element 38B based on software code stored in local memory. Thus, according to the techniques of this disclosure, creating UI elements 38A-38B via a shared worker 34 may reduce a need to access network 2 to acquire code to create UI elements 38A-38B.

In another example, the techniques of this disclosure provide for improved updating of one or more UI elements 38A-38B. For example, as shown in FIG. 2, browser 12 is operable to present a first UI element 38A to a user. The first UI element 38A us may have been created by shared worker 32 as described above. First UI element 38A may receive an update. For example where first UI element 38A is a chat window, first UI element 38A may receive a status update in the form of a chat message. According to known browser implementations, web application 35A would itself, based on code of web application 35A, update first UI element 38A to reflect the status update. According to techniques of this disclosure, instead of web application 35A itself updating first UI element 38A to reflect the status update, the status update may be sent to shared worker 34, and shared worker 34 may, in response, provide software code that may be executed to render an updated version of first UI element 38A.

In another example, the techniques of this disclosure provide for improved status synchronization for multiple UI elements 38A-38B. For example, as shown in FIG. 2, browser 12 is operated to present a first web application 35A and a second web application 35B to a user. The first and second web applications 35A, 35B may respectively present first and second UI elements 38A-38B. The first and second UI elements 38A-38B may represent substantially similar functionality. For example, the first and second UI elements 38A-38B may each represent functionality such as a chat window or contacts picker.

Shared worker 34 may enable communication of UI element 38A, 38B status local to computing device 10. For example, first UI element 38A may receive a status update (e.g., where first UI element 38A is a chat window, sub-component 38A may receive a user message). First UI element 38A or host web application 35A may communicate the status update to shared worker 34. Shared worker 34 may, upon receipt of the status update, communicate at least one software code portion updated to incorporate the received status update from first UI element 38A. Accordingly, the first and second UI elements 38A, 38B may be updated (e.g., by executing updated software code defining the UI elements 38A, 38B) to reflect the status update of first UI element 38A (e.g., the user message may be displayed to the user). In some examples, shared worker 34 may further store a received status update (and/or software code updated to incorporate the status update) locally, for example in a temporary memory of computing device 10, such that the status update may be provided to another UI element of web applications 35A, 35B, or another web application (not shown in FIG. 1) executed on computing device 10.

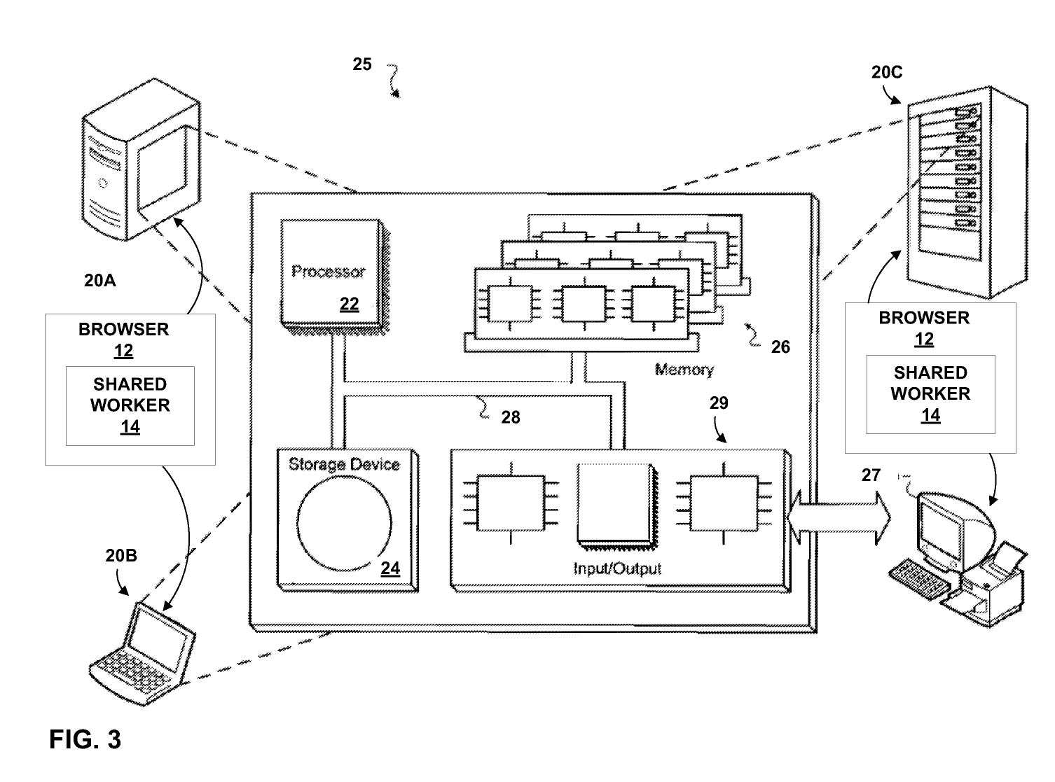

FIG. 3 is a conceptual diagram illustrating one example of components of computing systems 25 that may used by techniques described herein. As depicted in FIG. 3, computing system 25 may be included in various types of computing devices. For example, device 20A is a desktop computer. Device 20B is a laptop computer. Device 20C is a network server or mainframe computer. Although not depicted in FIG. 3, devices incorporating computing system 25 may instead include any number of other devices configured to compute and/or communicate via a network, including mobile devices such as mobile phones, personal digital assistants, smart phones, tablet computers, or any other mobile device. Also not depicted in FIG. 3, devices incorporating computing system 25 may include devices dedicated to other functions, for example a television configured to communicate via a network. Any of devices 20A-20C may be representative of local computing device 10 depicted in FIG. 1A and FIG. 2. Any of devices 20A-20C may also be representative of network servers 16A-16E depicted in FIG. 1A and FIG. 2.

System 25 includes a processor 22, a memory 26, a storage device 24, and an input/output component 29. Each of components 22, 24, 26, and 29 may be interconnected via a system bus 28 for inter-component communications. Processor 22 may be configured to process instructions for execution within system 25. Processor 22 may be a single threaded processor, or may instead be a multi-threaded processor configured to process various instructions in parallel simultaneously. Processor 22 may be capable of processing instructions stored in memory 26 or instructions stored on storage device 24. In one example, processor 22 may be configured to process instructions to cause a browser 12 to operate on system 25 consistent with techniques of this disclosure.

System 25 further may include peripheral devices 27. Peripheral devices 27 may include, for example, a monitor or other display device for presentation of visual information to a user of system 25. Peripheral devices 27 may further include one or more input devices to enable a user to input data to system 25, e.g., a keyboard, mouse, touchpad, trackpad, touch screen, etc. Peripheral devices 27 may further include printers, monitors, speakers, or other devices to output information.

In one example, processor 22 may be configured to process instructions to cause a visual depiction of a browser, e.g., browser 12 of FIG. 1A and FIG. 2, to be displayed to a user. As shown in FIG. 3, browser 12 may include a shared worker application 14 as described herein. Shared worker 14 may be configured to instantiate and/or enable local synchronization of sub-component instantiations for one or more web applications as described above. Browser 12 may operate on a processor of any of devices 20A-20D depicted in FIG. 3 and/or described above.

Memory 26 may be configured to store information within system 600 during operation. Memory 26 may be described as a computer-readable storage medium. In some examples, memory 26 is a temporary memory, meaning that a primary purpose of memory 26 is not long-term storage. Memory 26 may also be described as a volatile memory, meaning that memory 26 does not maintain stored contents when the computer is turned off. Examples of volatile memories include random access memories (RAM), dynamic random access memories (DRAM), static random access memories (SRAM), and other forms of memories known in the art.

In some examples, memory 26 may be used to store program instructions for execution by processor 22. In other examples, memory 26 may be used by software or applications running on system 25 to temporarily store information during program execution.

Storage device 24 may also be described as a computer-readable storage medium. In contrast to memory 26, storage device 24 may be configured to store larger amounts of information than memory 26. Storage device 24 may further be configured for long-term storage of information. In some examples, storage device 24 is a non-volatile memory component. In contrast with a volatile memory component, a non-volatile memory may store data whether or not power is supplied to storage device 24. Examples of non-volatile storage devices include magnetic hard discs, optical discs, floppy discs, Flash memories, and other forms of electrically programmable memories (EPROM) or electrically eraseable and programmable (EEPROM) memories.

The techniques described herein may be implemented according to a computing system 25 as described with respect to FIG. 3 in any combination of digital electronic circuitry, computer hardware, firmware, software, or any combination of digital electronic circuitry, computer hardware, firmware, software. For example, any of the techniques described herein may be implemented via executable program instructions stored in a computer-readable storage medium (e.g., storage device 24, memory 26) that are readable by processor 22 to cause processor 22 to perform the techniques of this disclosure. A computer readable medium as described herein may be considered a non-transient computer-readable medium. In other examples, some or all of the techniques of this disclosure may instead or in addition be implemented via dedicated hardware configured for a specific purpose, e.g., a field programmable gate array (FPGA), application specific integrated circuit (ASIC), digital signal processor (DSP) or like device.

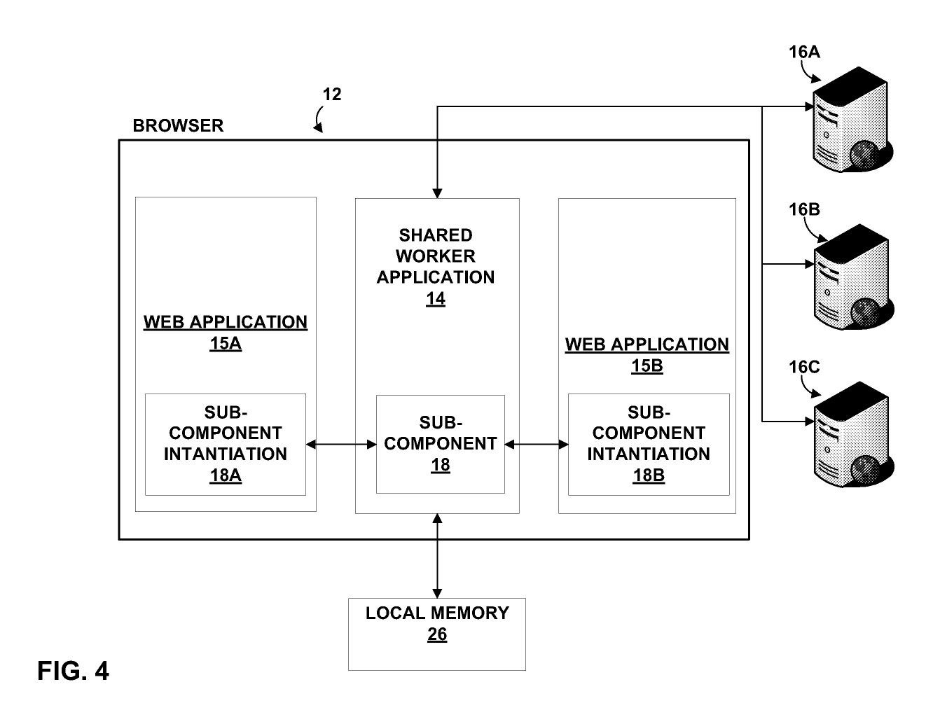

FIG. 4 is block diagram illustrating one example of a browser 12 that incorporates a shared worker application 14 configured to create an instantiation of one or more sub-components 18 and/or enable local synchronization of sub-component instantiations 18A, 18B status consistent with the techniques described herein. As shown in FIG. 4, browser 12 may be operable to display to a user a first web application 15A. The first web application 15A may desire to use functionality of a sub-component 18. The sub-component 18 defines at least some web application functionality and is configured to be used by more than one web application. In some examples, the at least one sub-component may present a visual depiction of web application functionality. In one example, the first web application 15A may communicate a request to shared worker application 14 to create an instantiation of the sub-component 18. In one example in which shared worker 14 is defined according to the HTML5 specification, a request may be an “instantiateComponent” request. The request may indicate that a sub-component instantiation 18A be created for a requesting web application 15A, or for a different web application (e.g., web application 15B in the FIG. 4 example).

In response to the request (or independent from it as shared worker 14 may independently create an instantiation of sub-component 18), shared worker 14 may create a first instantiation 18A of sub-component 18 for first web application 18A. In one example, creating an instantiation 18A of sub-component 18 by shared worker 14 may include shared worker 14 communicating one or more software code portions to define sub-component 18A. In one example, the one or more software code portions may be defined in the Javascript language commonly used for web application programming. In other examples, the one or more software code portions may be defined according to bytecode or instruction lists. Software code portions defined by other programming languages are also contemplated and consistent with the techniques of this disclosure. The one or more software code portions may be executed by one or more processors (e.g., processor 22 depicted in FIG. 2 above), to create sub-component instantiation 18A. Shared worker 14 may also store the one or more software code portions in a local memory 25 of computing device 10 for later use.

In one example, in response to a request to create a sub-component 18 instantiation 18A, a shared worker 14 may send a response message to a web application 15A that includes one or more of the following 1) an identifier for the sub-component and/or a particular instance of the sub-component, 2) a target for the sub-component (e.g., a frame or space on a web application for a visual depiction of the sub-component to be rendered, 3) a function for the sub-component instantiation to call when any event (e.g., a status change) is detected by the sub-component instantiation, and 4) a place in memory to store any information associated with the sub-component.

The above-mentioned contents of a response message may be included in the software code portion communicated to web application 15A. The above-mentioned contents may instead be communicated with the software code portion, or independently. In one specific example in which the above-described contents of a response message are defined according to the HTML5 specification, the target for the sub-component (2 above) may be identified by a “-targetElement” command, the function to call when any event is detected by the sub-component instantiation (3 above) may be identified by a -“eventFunct(event Message)” command, and the place to store information associated with the sub-component (4 above) may be defined by a “-uiContext” command.

Shared worker 14 may further control status updates for sub-component instantiation 18A. Sub-component instantiation 18A may receive a status update. According to examples in which sub-component instantiation 18A represents a chat window sub-component 18, sub-component instantiation 18A may receive a user message. According to known browser implementations, a status update received by sub-component instantiation 18A may be processed by code of web application 15A, and web application 15A may operate to render a visual depiction of sub-component instantiation 18A according to the update. However, according to techniques described herein, a status update may be communicated to shared worker 14, either by sub-component instantiation 18A itself, or by host web application 15A. In response, shared worker 14 may update software code defining the sub-component 18 to incorporate the status update. Accordingly, an updated version of software code defining the sub-component 18 may be executed to render a visual depiction of sub-component instantiation 18A consistent with the status update.

As also shown in FIG. 4, a browser 12 may operate a second web application 15B. Like first web application 15A, second web application 15B may desire to utilize functionality associated with sub-component 18. As such, second web application 15B may communicate to shared worker 14 a request to instantiate sub-component 18. In response to the request (or independently, as shared worker 14 itself may determine whether to instantiate sub-component 18), shared worker 14 may create sub-component instantiation 18B for host web application 15B. In one example, creating sub-component instantiation 18B includes shared worker 14 communicating one or more software code portions that define sub-component 18 to second web application 15B. In one example, the one or more software code portions that define sub-component 18 may be accessed from a local memory (e.g., local memory 25 as shown in FIG. 3 above). In one example, the one or more software code portions that define sub-component 18 may have been previously stored when shared worker 14 created sub-component instantiation 18A. The one or more software code portions may be executed by one or more processors (e.g., processor 22 depicted in FIG. 3 above), to create sub-component instantiation 18B.

The examples discussed above with respect to FIG. 4 assume that that a shared worker 14 is already running on browser 12 when one or more of web applications 15A, 15B desire to use sub-component 18 functionality. In other examples, shared worker 14 may not be running in browser 12. According to these examples, the one or more web applications 15A, 15B may cause shared worker 14 to be instantiated. In other examples, a request for sub-component 18 instantiation from one or more of web applications 15A, 15B may automatically result in instantiation of a shared worker 14, which may then acquire software code defining the sub-component 18 for instantiation as described above.

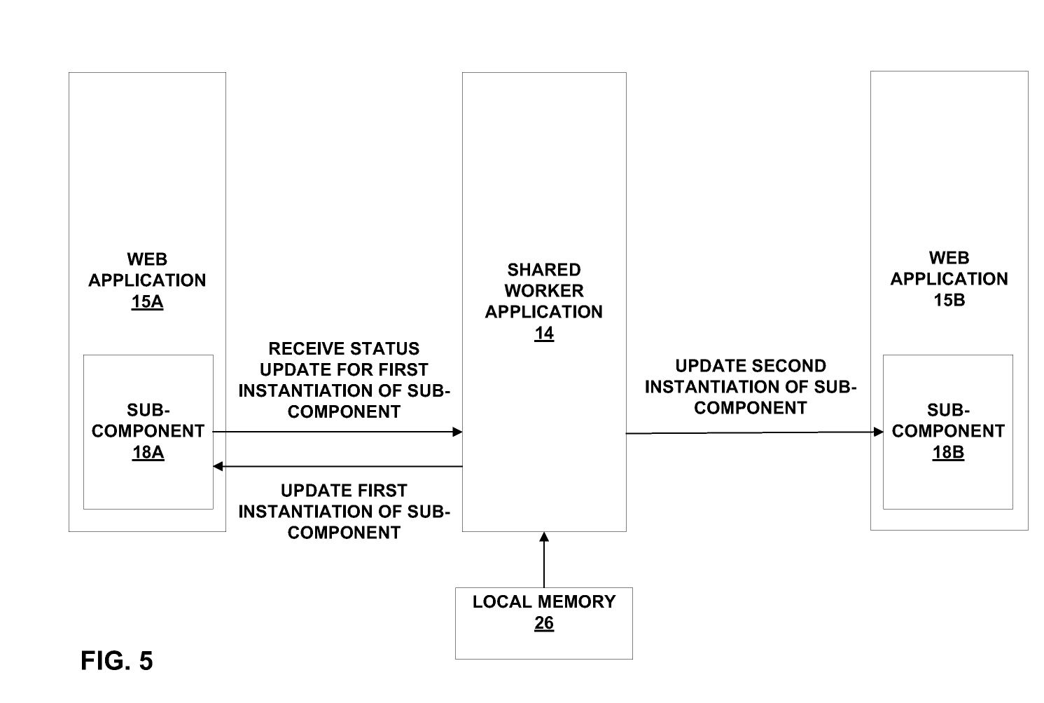

FIG. 5 is a conceptual diagram illustrating a shared worker application 14 that enables local synchronization of sub-component status consistent with the techniques of this disclosure. As shown in FIG. 5, first web application 15A that includes a first instantiation 18A of a sub-component 18 is operating in browser 12. As also shown in FIG. 5, a second web application 15B that includes a second instantiation 18B of a sub-component 18 is operating in browser 12. The first web application 15A may be a second instantiation of the same web application as web application 15B (e.g., independent windows or tabs of browser 12 pointing to the same URL). The first web application 15A may instead be a different web application than second web application 15B.

In one example, sub-component instantiation 18A may receive a status update. A status update may be initiated by a user, or otherwise (e.g., by web application 15A). In one example, where sub-component 18 is a chat window, the status update to sub-component instantiation 18A may indicate that a user has entered text into the chat window. In another example, where sub-component 18 is a contacts picker, the status update to sub-component instantiation 18A may indicate that a user has entered or selected a new contact.

As shown in FIG. 5, sub-component instantiation 18A (or web application 15A) may communicate the status update to shared worker 14. In one example, shared worker 14 may then communicate the status update to second sub-component instantiation 18B. Second sub-component 18B may then update its status based on the received status update. For example, where sub-component 18 is a chat window, second sub-component instantiation may reflect user-entered text (e.g., entered via first sub-component instantiation 18A) in second sub-component instantiation 18B. In another example, where sub-component 18 is a contacts picker, second sub-component instantiation 18B may reflect user entry of a new contact, or user selection of a contact, via sub-component instantiation 18A.

In another example, in response to the status update received from sub-component 18A, shared worker 14 may update software code defining sub-component 18 to incorporate the status update. For example, shared worker 14 may access the software code originally used to create sub-component instantiations 18A and 18B to incorporate the status update. The software code originally used to create sub-component instantiations 18A, 18B may have been stored in local memory. In one example, where sub-component 18 is a chat window, shared worker 14 may update software code to define a visual depiction of the chat window to reflect a status update (e.g., a entered user message). Shared worker 14 may then resend, to one or more of web applications 15A and 15B, the updated software code. The updated software code may then be executed such that sub-component instantiations 18A, 18B are updated to reflect the status update (the new message).

Sub-component instantiation 18A may communicate a status update to shared worker 14 based on a command identified when the sub-component instantiation 18A was created. In one specific example where shared worker 14 is defined according to the HTML 5 specification, a function to call when an event update (change in sub-component instantiation state) occurs, a notifyOfEvent(componentID, eventMessage) function may be called by sub-component instantiation 18A to communicate the status update to shared worker 14.

As also shown in FIG. 5, shared worker 14 may access local memory (e.g., local memory 25 in FIG. 3) to store data. Accordingly, when a status update for one or more of sub-components 18A, 18B is received by shared worker 14, shared worker 14 may store the status update in local memory 26. Shared worker 14 may utilize the stored status update to update other instantiations of sub-component 18 (not shown in FIG. 4A). In other examples, shared worker 14 may update software code defining sub-component 18 to reflect a status update. According to these examples, the updated code may be stored in local memory 26 for later use. In one example, if a user opens a third web application that desires to use functionality associated with sub-component 18, shared worker 14 may use a stored status update and/or updated software code to create a third instantiation (not shown in FIG. 5) of the sub-component 18. As such, the third instantiation of sub-component 18 may, upon being created, reflect the same information as previously active instantiations 18A and 18B of sub-component 18.

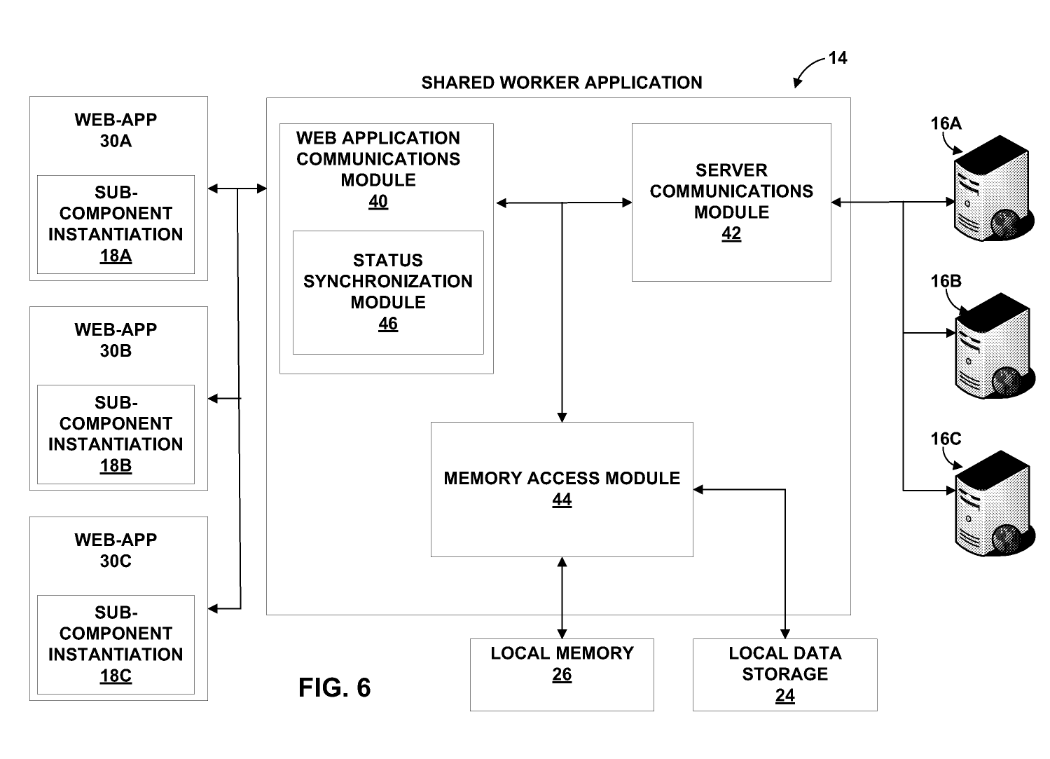

FIG. 6 is a block diagram illustrating components of a shared worker application 14 consistent with this disclosure. As shown in FIG. 6, shared worker 14 includes a web application communications module 40 (hereinafter web app module 40), a server communications module 42 (hereinafter server module 42), and a memory access module 44.

Web app module 40 may generally be configured to communicate with one or more web applications 30A-30C. For example, web app module 40 may receive requests for information (and/or requests to create one or more sub-component instantiations) from one or more of web apps 30A-30C and, in response to a request, communicate with server module 42 to acquire the requested information (e.g., software code defining a sub-component) from one or more network servers 16A-16C via a network 2. Also in response to the request, memory access module 44 may store acquired information in local memory 25 for later use, such as where a second web application requests the same or similar information that may be satisfied by information stored in local memory.

In another example, web app module 40 may communicate with memory access module 44 to satisfy a request for information. In response to a request, memory access module 44 may determine whether information stored in local memory 25 may satisfy the request. If the request may be satisfied, shared worker 14 may access the information stored in local memory 25 and provide the information to one or more requesting web applications 30A-30C. As also shown in FIG. 5, in another example, memory access module 24 may be further configured to access local data storage 24 of a computing device. According to this example, acquired information may be stored in local data storage 24 so that when browser 12, and/or a computing device upon which browser 12 is operating, ceases operation, stored information may still be accessed without being acquired from one or more network servers 16A-16C.

Web app module 40 may further communicate with one or more web applications 30A-30C to receive requests to create an instantiation a sub-components 18. In one example, in response to such a request, web app module 40 may communicate with server communications module 42 to acquire, from one or more network servers 16A-16C, at least one software code portion defining the sub-component 18. Web app module 40 may then communicate the at least one software code portion to a requesting web application 30A-30C. The software code portion may be executed, thereby creating an instantiation 18A of the sub-component 18. In another example, web app module 40 may instead communicate with memory access module 44 to acquire the at least one software code portion. For example, memory access module 44 may determine whether one or more code segments defining the requested sub-component 18 are stored in local memory, and if the one or more code segments are stored in local memory, communicate the one or more code segments to a requesting web application 30A-30C for execution, thereby creating an instantiation 18A of the sub-component 18. However, if the one or more code segments are not stored in local memory, web app module 40 may communicate with server module 42 to acquire the one or more code segments as described above.

As also shown in FIG. 6, web app module 40 may include a status synchronization module 46. Status synchronization module 46 may be operative to enable, via shared worker 14, local synchronization of status between multiple sub-component instantiations 18A-18C. The multiple sub-component instantiations 18A-18C may instantiated in different web applications (e.g., a first sub-component instantiation for web application 30A, and a second sub-component instantiation for web application 30B), or multiple sub-component instantiations may be instantiated in a single web application (e.g., web application 30A). To synchronize sub-component 18 status, status synchronization module 46 may receive, from one or more sub-component instantiations 18A-18C of web applications 30A-30C, an indication of sub-component 18 status.

In one example, status synchronization module 46 may analyze the received indication of sub-component 18 status to determine whether some or all sub-component instantiations 18A-18C should be updated due to the status update. According to this example, status synchronization module 46 may acquire, via memory access module 44 or server module 42, software code defining the sub-component 18. Status synchronization module 46 may then update the software code defining the sub-component 18 consistent with the received status update, and communicate the updated software code to one or more web applications 30A-30C. The updated software code may then be executed to update sub-component instantiations 18A-18C. Status synchronization module 46 may further communicate with memory access module 44 to store the updated software code for later use.

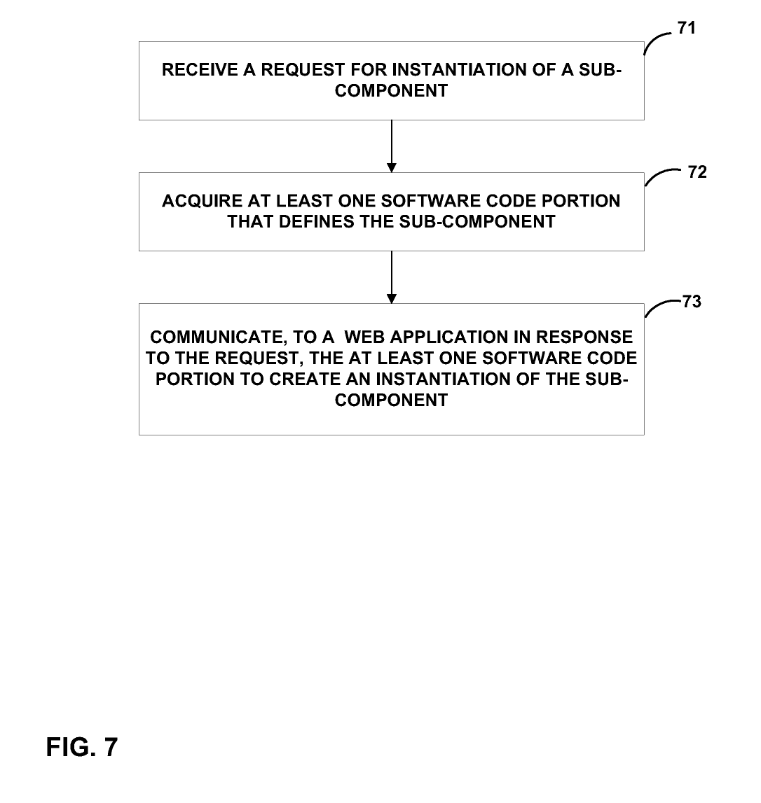

FIG. 7 is a flow chart diagram illustrating one example of a method consistent with the techniques of this disclosure. The method includes receiving a request for instantiation of a sub-component 18 from a web application 15A operating on a computing device (71). The method further includes acquiring at least one software code portion that defines the sub-component 18 (72). In one example, the method includes acquiring the at least one software code portion from one or more network servers 16A-16C. In another example, the method includes acquiring the at least one software code portion from a local memory 25 of the computing device 10. In another example, the method may further include determining whether at least one software code portion that will satisfy the request is stored in the local memory 25 of the computing device and, if the local memory 25 does not include at least one software code portion that will satisfy the request, acquiring the at least one software code portion from one or more network servers 16A-16C. The method further includes communicating, to the web application 15A in response to the request, the at least one software code portion to create an instantiation 18A of the sub-component 18 (73). In one examples, the at least one software code portion is communicated local to the computing device 10 to create the instantiation 18A of the sub-component 18.

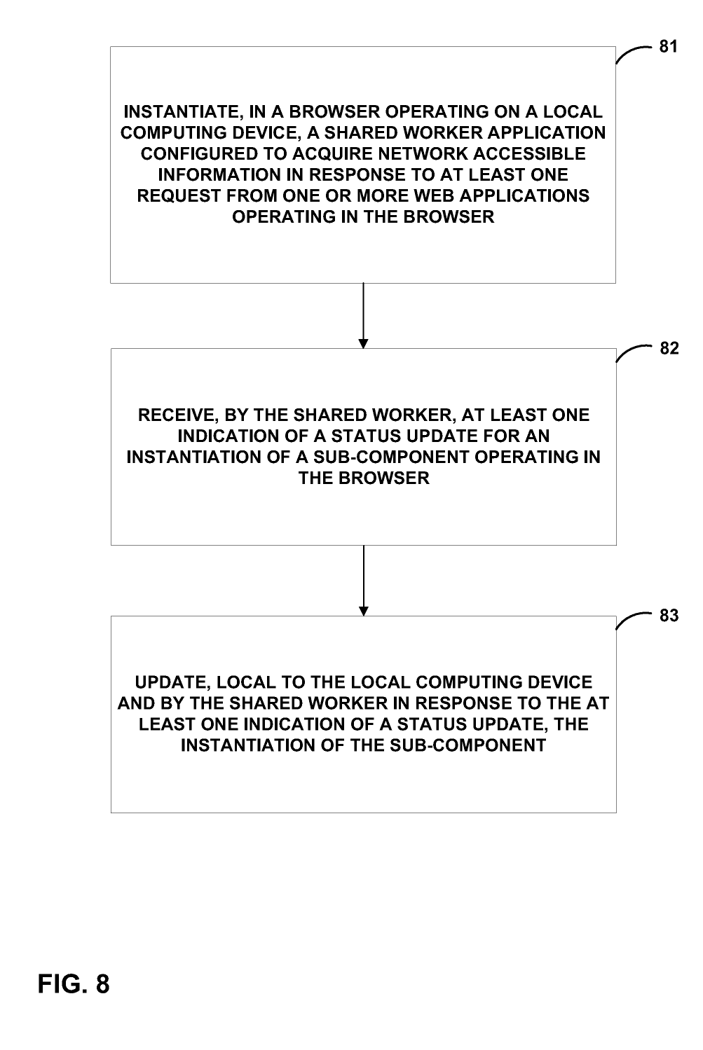

FIG. 8 is a flow chart diagram illustrating one example of a method consistent with the techniques of this disclosure. The method includes instantiating, in a browser operating on a computing device, a shared worker application configured to acquire network accessible information in response to at least one request from one or more web applications operating in the browser (81). The method further includes receiving, by the shared worker 14, at least one indication of a status update for a sub-component 18, wherein at least one instantiation of the sub-component is operating in the browser (82).

The at least one indication of a status update for sub-component 18 may be received from the instantiation 18A of the sub-component, from another instantiation 18B of the sub-component 18, or from a host web application 15A. The instantiation 18A of the sub-component 18 may have been created by a shared worker 14 as described above. The method further includes updating, local to the computing device and by the shared worker in response to the at least one indication of a status update, the at least one instantiation 18A of the sub-component (83). In one example, updating the at least one instantiation 18A, 18B of the sub-component includes communicating at least one software code portion updated to reflect the at least one indication of a status update. In another example, steps 82 and 83 may be repeated. For example, if shared worker 14 receives a second indication of a status update for sub-component 18, shared worker may, in response to the second indication of a status update, update at least one instantiation 18A of the sub-component.

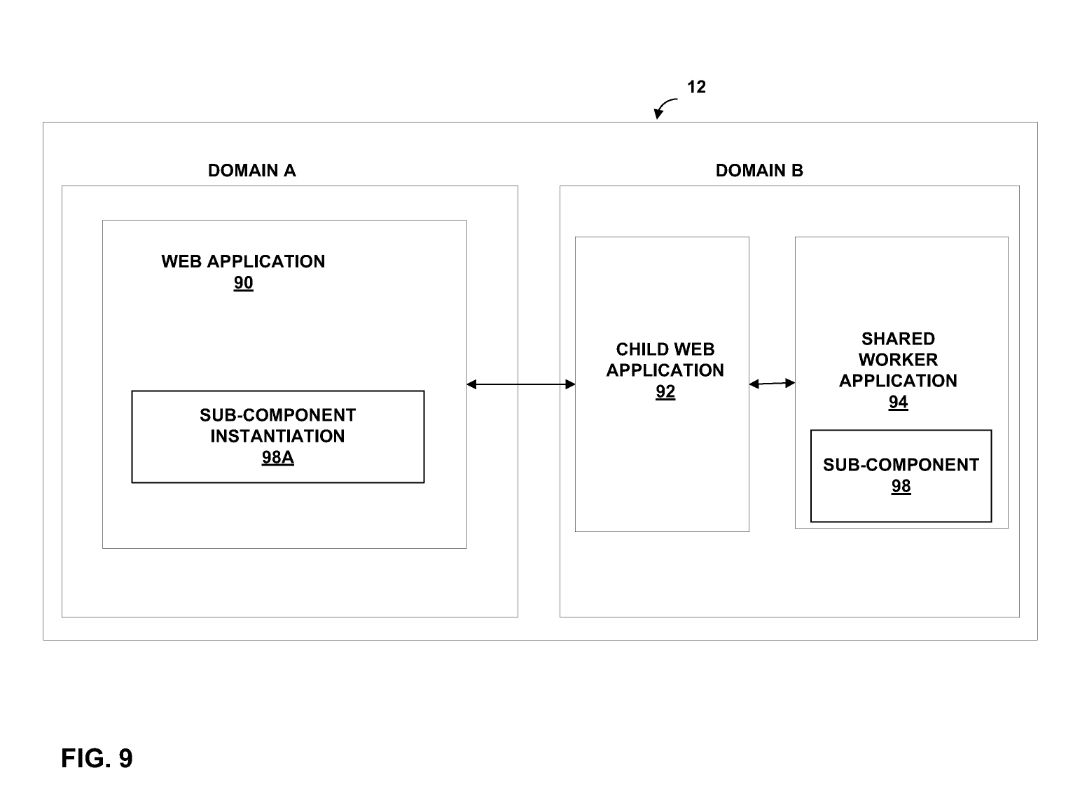

FIG. 9 is a block diagram illustrating one example of a shared worker application configured to instantiate and/or enable communication with/between instantiations of one or more sub-components 18 according to the techniques of this disclosure. The examples of a shared worker 14 discussed above are directed towards a shared worker 14, and web applications 15A-15B (30A-30C), configured to operate on the same web domain. A domain as discussed herein may be described as the portion of a URI before the first forward slash (e.g., for the URI www.google.com/contacts, the domain is www.google.com). For security purposes, known web browsers 12 limit communications between web applications operating on different domains. As depicted in FIG. 9, the techniques of this disclosure may be applicable cross-domain as well as intra-domain as described above.

As shown in FIG. 9, a web application 90 is operating in browser 12. Web application 90 is associated with a first domain, domain A. Shared worker 94 is associated with a second domain, domain B. Web application 90 may desire for a sub-component 98 to be instantiated for web application 90. However, unlike the examples described above, the sub-component 98 may be associated with a second domain different than domain A, domain B. Due to security requirements of browser 12, web application 90 may be prevented from communicating with web applications of domain B, including shared worker 94. As such, in order to initiate cross-domain communications, web application 90 may cause a child web application 92 to be created. In one example, child web application 92 is created associated with domain A, and then associated with domain B. In another example, child web application 92 is created associated with domain B. In one example, child web application 92 is an inline frame web application (“iframe”) as is well known in the relevant arts.

Child web application 92 may operate as a proxy for communications between web application 90 and shared worker 94 and/or other web applications associated with domain B. Initially, child web application 92 may block any communications from web application 90. Child web application 92 may first securely authenticate web application 90 associated with domain A before allowing cross-domain communications with web application 90. Child web application 92 may securely authenticate web application 90 associated with domain A by various mechanisms known in the art, including secure token exchange and/or white-list comparison.

Once securely authenticated, child web application 92 may remain active to operate as a proxy for cross-domain communications. In one example, web application 90 may desire to use functionality of a sub-component associated with domain B. As such, web application 90 may communicate a request for creation of an instantiation 98A of a sub-component 98 as described above. The sub-component 98 may be a component configured to provide web functionality for more than one web application. Child web application 92 may receive the request, and determine whether shared worker 94 is operating associated with domain B. If the shared worker 94 is not operating associated with domain B, child web application 92 may cause shared worker 94 to be instantiated.

Child web application 92 may forward the request for instantiation of a sub-component 98 to shared worker application 94. As described above, shared worker application 94 may attempt to determine whether software code defining the requested sub-component 98 is stored in a local memory of a computing device upon which browser 12 is operating. If software code defining the requested sub-component 98 is stored in a local memory of the computing device, then shared worker 94 may, via child web application 92, communicate the software code to web application 90 to create sub-component instantiation 98A. If software code defining the sub-component 98 is not stored in local memory, shared worker 94 may communicate, via a network, with one or more network servers to acquire the software code. Once acquired, shared worker 94 may, via child web application 92, communicate the software code to web application 90 to create sub-component instantiation 98A. Shared worker 94 may further store acquired software code defining a sub-component 98 in local memory, for later use.

In another example not depicted in FIG. 9, shared worker 94 may enable status synchronization between an instantiation 98A of a sub-component 98 associated with domain A with another instantiation (not shown in FIG. 9) of the sub-component 98 associated with domain B. For example, if a second instantiation of the sub-component 98 associated with sub-component instantiation 98 was operating associated with domain B, shared worker application 94 may, in response to a status update from sub-component instantiation 98A received via child web application 92, update software code defining the sub-component. Shared worker 94 may then communicate the updated software code to sub-component instantiation 98A and/or the second sub-component instantiation associated with domain B. Accordingly, status of sub-component instantiation 98 and the second sub-component instantiation associated with domain B may be synchronized local to a computing device upon which browser 12 is operating.

The examples described above with respect to FIG. 9 may be advantageous, because utilizing cross-domain communications to instantiate and/or enable local status synchronization between sub-components (e.g., sub-component 98), the above-described inefficiencies resulting from known implementations of web browsers with respect to sub-component sharing may be more greatly reduced, because the need for network communications is further minimized.

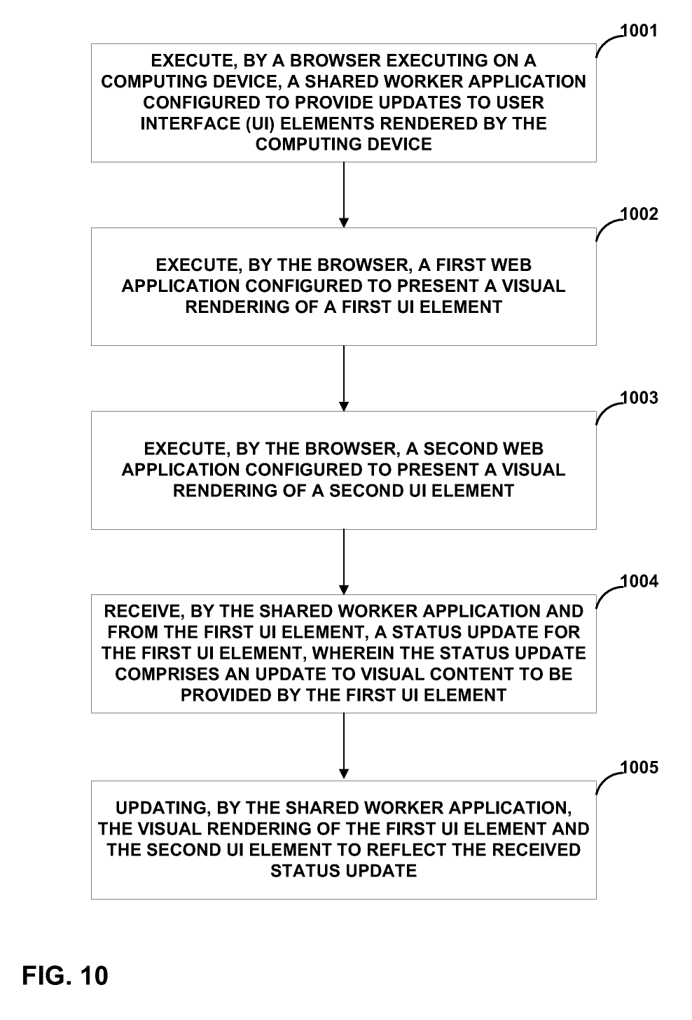

FIG. 10 is a flow chart diagram illustrating one example of a method consistent with the techniques of this disclosure. The method includes executing, by a browser 12 executing on a computing device 10, a shared worker application 34 configured to provide updates to user interface (UI) elements 38A, 38B rendered by the computing device (1001). The method further includes executing, by the browser 12, a first web application 35A configured to present a visual rendering of a first UI element 38A (1002). The method further includes executing, by the browser 12, a second web application 35B configured to present a visual rendering of a second UI element 38B, wherein the second UI element 38B is substantially similar to the first UI element 38A (1003). The method further includes receiving, by the shared worker application 34 and from the first UI element 38A, a status update for the first UI element 38A, wherein the status update comprises an update to visual content to be provided by the first UI element 38A. The method further includes updating, by the shared worker application 34, the visual rendering of the first UI element 38A and the second UI element 38B to reflect the received status update.

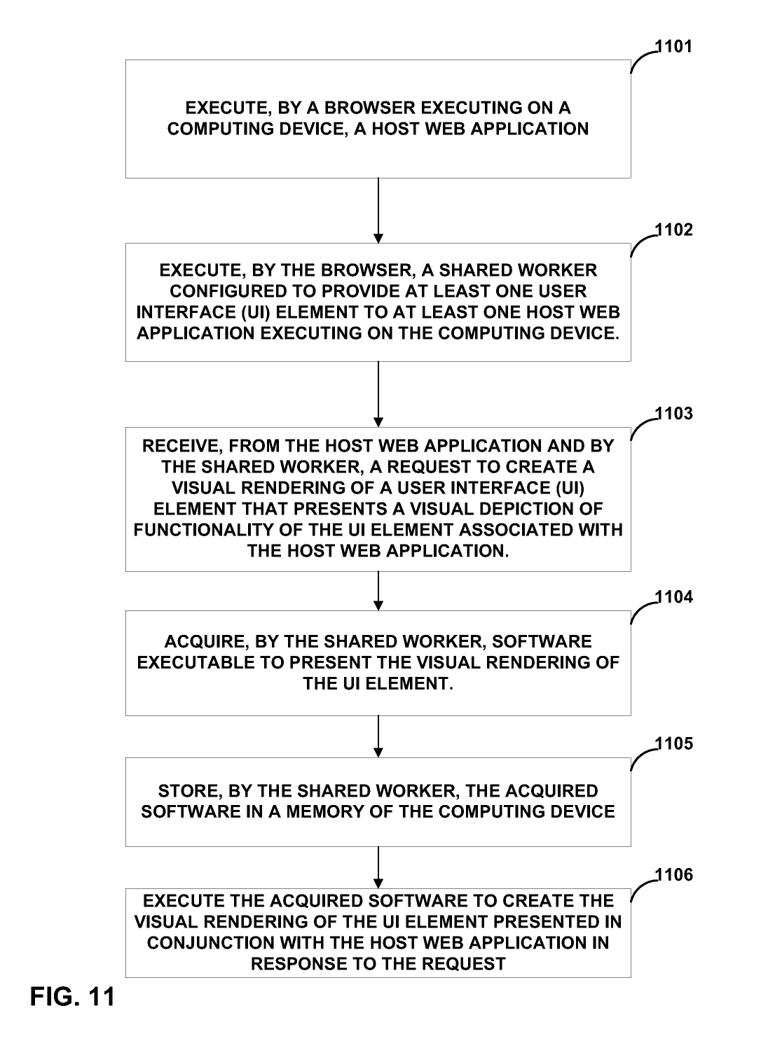

FIG. 11 is a flow chart diagram illustrating one example of a method consistent with the techniques of this disclosure. The method includes executing, by browser 12 executing on a computing device 10, a host web application 35A (1101). The method further includes executing, by the browser 12, a shared worker 34 configured to provide at least one user interface (UI) element to at least one host web application executing on the computing device (1102). The method further includes receiving, from the host web application 35A and by the shared worker 34, a request to create a visual rendering of a user interface (UI) element 38A that presents a visual depiction of functionality of the UI element 38A associated with the host web application 35A (1103). The method further includes acquiring, by the shared worker 34, software executable to present the visual rendering of the UI element 35A (1104). The method further includes storing, by the shared worker 34, the acquired software in a memory of the computing device 10 (1105). The method further includes executing the acquired software to create the visual rendering of the UI element 38A presented in conjunction with the host web application 25A in response to the request (1106).

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in a computer-readable medium, such as a computer-readable storage medium, containing instructions. Instructions embedded or encoded in a computer-readable medium, including a computer-readable storage medium, may cause one or more programmable processors, or other processors, to implement one or more of the techniques described herein, such as when instructions included or encoded in the computer-readable medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may comprise one or more computer-readable storage media.

Various embodiments of the disclosure have been described. These and other embodiments are within the scope of the following claims.

1. A method for providing updates to visual user interface elements, the method comprising:
executing, by a browser executing on a computing device, a shared worker application configured to provide updates to user interface (UI) elements rendered by the computing device;
executing, by the browser, a first web application configured to present a visual rendering of a first UI element;
executing, by the browser, a second web application configured to present a visual rendering of a second UI element, wherein the second UI element is substantially similar to the first UI element;
receiving, by the shared worker application and from the first UI element, a status update for the first UI element, wherein the status update comprises an update to visual content to be provided by the first UI element; and
updating, by the shared worker application, the visual rendering of the first UI element and the second UI element to reflect the received status update.

2. The method of claim 1, wherein updating the visual rendering of the first UI element and the second UI element to reflect the received status update comprises:
acquiring, by the shared worker application, software executable to define the visual rendering of at least the first UI element;
modifying the software to reflect the received status update;
executing the software to update the visual rendering of the first UI element; and
executing the software to update the visual rendering of the second UI element.

3. The method of claim 2, wherein acquiring the software executable to define the visual rendering of at least the first UI element comprises:
acquiring the software from a memory of the computing device.

4. The method of claim 2, wherein acquiring the software executable to define the visual rendering of at least the first UI element comprises:
acquiring the software from a network server via a network connection.

5. The method of claim 2, further comprising:
storing the software modified to reflect the received status update in a local memory of the computing device.

6. The method of claim 5, further comprising:
receiving, by the shared worker, a request to create a third UI element substantially similar to the first and second UI elements; and
executing, by the shared worker, the stored software modified to reflect the received status update to create the third UI element to reflect the received status update.

7. The method of claim 1, wherein the first UI element represents functionality of the first web application, and wherein the functionality of the first web application is selected from the group consisting of:
an instant messaging window;
a contact picker;
a calendar event entry/update window;
a photo upload and/or presentation window; and
an audio/video presentation/player window.

8. An article of manufacture comprising a computer-readable storage medium storing instructions that cause a computing device to:
execute, by a browser executing on a computing device, a shared worker application configured to provide updates to user interface (UI) elements rendered by the computing device;
execute, by the browser, a first web application configured to present a visual rendering of a first UI element;
execute, by the browser, a second web application configured to present a visual rendering of a second UI element, wherein the second UI element is substantially similar to the first UI element;
receive, by the shared worker application and from the first UI element, a status update for the first UI element, wherein the status update comprises an update to visual content to be provided by the first UI element; and
update, by the shared worker application, the visual rendering of the first UI element and the second UI element to reflect the received status update.

9. The article of manufacture of claim 8, wherein the computer-readable storage medium further stores instructions that cause the computing device to:
acquire, by the shared worker application, software executable to define the visual rendering of at least the first UI element;
modify the software to reflect the received status update;
execute the software to update the visual rendering of the first UI element; and
execute the software to update the visual rendering of the second UI element.

10. The article of manufacture of claim 8, wherein the computer-readable storage medium further stores instructions that cause the computing device to: acquire the software from a memory of the computing device.

11. The article of manufacture of claim 8, wherein the instructions further cause the computing device to:
acquire the software from a network server via a network connection.

12. The article of manufacture of claim 8, wherein the computer-readable storage medium further stores instructions that cause the computing device to:
store the software modified to reflect the received status update in a local memory of the computing device.

13. The article of manufacture of claim 12, wherein the computer-readable storage medium further stores instructions that cause the computing device to: receive, by the shared worker, a request to create a third UI element substantially similar to the first and second UI elements; and
execute, by the shared worker, the stored software modified to reflect the received status update to create the third UI element to reflect the received status update.

14. The article of manufacture of claim 12, wherein the first UI element represents functionality of the first web application, and wherein the functionality of the first web application is selected from the group consisting of:
an instant messaging window;
a contact picker;
a calendar event entry/update window;
a photo upload and/or presentation window; and
an audio/video presentation/player window.

15. A device, comprising:
a browser configured to execute a shared worker application configured to provide updates to user interface (UI) elements rendered by the computing device, and wherein the browser is further configured to execute a first web application configured to present a visual rendering of a first UI element and a second web application configured to present a visual rendering of a second UI element;
means for receiving, from the first UI element and by the shared worker application, a status update for the first UI element, wherein the status update comprises an update to visual content to be provided by the first UI element; and
means for updating, by the shared worker application, the visual rendering of the first UI element and the second UI element to reflect the received status update.

16. The device of claim 15, further comprising:
means for acquiring software executable to define the visual rendering of at least the first UI element;
means for modifying the software to reflect the received status update;
means for executing the software to update the visual rendering of the first UI element; and
means for executing the software to update the visual rendering of the second UI element.

17. The device of claim 16, wherein the means for acquiring software executable to define the visual rendering of at least the first UI element comprises means for acquiring the software from a memory of the computing device.

18. The device of claim 16, wherein the means for acquiring software executable to define the visual rendering of at least the first UI element comprises means for acquiring the software from a network server via a network connection.

19. The device of claim 16, further comprising:
means for storing the software modified to reflect the received status update in a local memory of the computing device.

20. The device of claim 19, further comprising:
means for receiving a request to create a third UI element substantially similar to the first and second UI elements; and
means for executing the stored software modified to reflect the received status update to create the third UI element to reflect the received status update.

21. A method for presenting a visual user interface element via a web application, the method comprising:
executing, by a browser executing on a computing device, a host web application;
executing, by the browser, a shared worker configured to provide at least one user interface (UI) element to at least one host web application executing on the computing device;
receiving, from the host web application and by the shared worker, a request to create a visual rendering of a user interface (UI) element that presents a visual depiction of functionality of the UI element associated with the host web application;
acquiring, by the shared worker, software executable to present the visual rendering of the UI element;
storing, by the shared worker, the acquired software in a memory of the computing device; and
executing the acquired software to create the visual rendering of the UI element presented in conjunction with the host web application in response to the request.

22. The method of claim 21, wherein the UI element is a first UI element, and wherein the method further comprises:
receiving, by the shared worker, a second request to create a visual rendering of a second UI element; and
executing, the acquired software to create the visual rendering of the second UI element in response to the second request.

23. The method of claim 21, wherein acquiring the software executable to define the visual rendering of at least the first UI element comprises:
acquiring the software from a memory of the computing device.

24. The method of claim 21, wherein acquiring the software executable to define the visual rendering of at least the first UI element comprises:
acquiring the software from a network server via a network connection.

25. The method of claim 21, wherein the visual depiction of functionality of the UI element associated with the host web application is selected from the group consisting of:
an instant messaging window;
a contact picker;
a calendar event entry/update window;
a photo upload and/or presentation window; and
an audio/video presentation/player window.

26. The method of claim 21, wherein storing the acquired software in a memory of the computing device comprises storing the acquired software in a volatile memory of the computing device.

27. An article of manufacture comprising a computer-readable storage medium that stores instructions that cause a computing device to:
execute, by browser executing on a computing device, a host web application;
execute, by the browser, a shared worker configured to provide at least one user interface (UI) element to at least one host web application executing on the computing device;
receive, from the host web application and by the shared worker, a request to create a visual rendering of a user interface (UI) element that presents a visual depiction of functionality of the UI element associated with the host web application;
acquire, by the shared worker, software executable to present the visual rendering of the UI element;
store, by the shared worker, the acquired software in a memory of the computing device; and
execute the acquired software to create the visual rendering of the UI element presented in conjunction with the host web application in response to the request.

28. The article of manufacture of claim 21, wherein the UI element is a first UI element, and wherein the instructions further cause the computing device to:
receive, by the shared worker, a second request to create a visual rendering of a second UI element; and
execute, the acquired software to create the visual rendering of the second UI element in response to the second request.

29. The article of manufacture of claim 21, wherein the instructions cause the computing device to:
acquire the software from a memory of the computing device.

30. The article of manufacture of claim 21, wherein the instructions cause the computing device to:
acquire the software from a network server via a network connection.

31. The article of manufacture of claim 21, wherein the visual depiction of functionality of the UI element associated with the host web application is selected from the group consisting of:
an instant messaging window;
a contact picker;
a calendar event entry/update window;
a photo upload and/or presentation window; and
an audio/video presentation/player window.

32. The article of manufacture of claim 21, wherein the instructions further cause the computing device to store the acquired software in a volatile memory of the computing device.

33. A device, comprising:
a host web application executed by a browser;
a shared worker application executed by the browser, wherein the shared worker application comprises:
means for receiving, from the host web application, a request to create a visual rendering of a user interface (UI) element that presents a visual depiction of functionality of the UI element associated with the host web application;
means for acquiring software executable to present the visual rendering of the UI element;
means for storing the acquired software in a memory of the computing device; and
means for executing the acquired software to create the visual rendering of the UI element presented in conjunction with the host web application in response to the request.

34. The device of claim 33, wherein the UI element is a first UI element, and wherein the shared worker further comprises:
means for receiving a second request to create a visual rendering of a second UI element; and
means for executing the acquired software to create the visual rendering of the second UI element in response to the second request.

35. The device of claim 33, wherein the means for acquiring software executable to present the visual rendering of the UI element acquire the software from a memory of the computing device.

36. The device of claim 33, wherein the means for acquiring software executable to present the visual rendering of the UI element acquire the software from a network server via a network connection.

37. The device of claim 33, wherein the visual depiction of functionality of the UI element associated with the host web application is selected from the group consisting of:
an instant messaging window;
a contact picker;
a calendar event entry/update window;
a photo upload and/or presentation window; and
an audio/video presentation/player window.

38. The device of claim 33, wherein the means for storing the acquired software in a memory of the computing device store the acquired software in a volatile memory of the computing device.
